(19) United States
(12) Patent Application Publication
(10) Pub. No.: US 2023/0344004 A1
(43) Pub. Date: Oct. 26, 2023

(54) ELECTROLYTE FOR RECHARGEABLE LITHIUM BATTERY AND RECHARGEABLE LITHIUM BATTERY INCLUDING SAME

(71) Applicant: SAMSUNG SDI CO., LTD., Yongin-si, Gyeonggi-do (KR)

(72) Inventors: Dahyun KIM, Yongin-si (KR); Minseo KIM, Yongin-si (KR); Sanghyung KIM, Yongin-si (KR); Sanghoon KIM, Yongin-si (KR); Hyejin PARK, Yongin-si (KR); Myungheui WOO, Yongin-si (KR); Bokyung RYU, Yongin-si (KR); Tae Jin LEE, Yongin-si (KR); Wonseok CHO, Yongin-si (KR)

(21) Appl. No.: 18/013,824

(22) PCT Filed: Dec. 6, 2021
(86) PCT No.: PCT/KR2021/018319

§ 371 Date: Dec. 29, 2022

(30) Foreign Application Priority Data
Jan. 22, 2021 (KR) 10-2021-0009659

(51) Int. Cl. H01M 10/0567; H01M 10/0569; H01M 10/0525

(52) U.S. Cl. CPC H01M 10/0567; H01M 10/0525; H01M 10/0569; H01M 2300/004

(57) ABSTRACT

Provided are an electrolyte for a rechargeable lithium battery and a rechargeable lithium battery including same, the electrolyte including a nonaqueous organic solvent, a lithium salt, and an additive, wherein the additive is a composition comprising a first compound represented by Chemical Formula 1 and a second compound represented by Chemical Formula 2.

The details of Chemical Formulas 1 and 2 are as set forth in the specification.

### TECHNICAL FIELD

This disclosure relates to an electrolyte for a rechargeable lithium battery and a rechargeable lithium battery including the same.

### BACKGROUND ART

A rechargeable lithium battery may be recharged and has three or more times as high energy density per unit weight as a conventional lead storage battery, nickel-cadmium battery, nickel hydrogen battery, nickel zinc battery and the like. It may be also charged at a high rate and thus, is commercially manufactured for a laptop, a cell phone, an electric tool, an electric bike, and the like, and researches on improvement of additional energy density have been actively made.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

Particularly, the electrolyte uses an organic solvent in which a lithium salt is dissolved, and such an electrolyte is important in determining stability and performance of a rechargeable lithium battery.

Recently, a safety problem has emerged due to an increase in energy density due to a high capacity of a rechargeable lithium battery, and a method of using a flame retardant as an additive for an electrolyte is known as one of the methods for improving safety.

As the flame retardant, fluorine-based compounds, phosphorus-based compounds, sulfur-based compounds, and the like are mainly used as compounds having low environmental pollution issues and flame retardancy, but the use of these flame retardants may cause deterioration in battery performance.

Accordingly, there is a demand for an electrolyte having improved battery performance while ensuring safety.

### DISCLOSURE

### Technical Problem

An embodiment provides an electrolyte for a rechargeable lithium battery with improved high-temperature storage characteristics while securing battery safety such as thermal stability and penetration stability.

Another embodiment provides a rechargeable lithium battery having improved high-temperature storage characteristics by applying the electrolyte to improve high-temperature safety and, in particular, to reduce gas generation and a resistance increase rate during high-temperature storage.

### Technical Solution

An embodiment of the present invention provides an electrolyte for a rechargeable lithium battery including a non-aqueous organic solvent, a lithium salt, and an additive, wherein the additive includes a composition including a first compound represented by Chemical Formula 1 and a second compound represented by Chemical Formula 2.

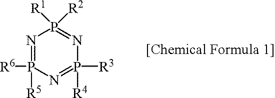

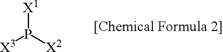

In Chemical Formula 1 and Chemical Formula 2,
R¹ to R⁶ are each independently hydrogen, a halogen, a substituted or unsubstituted C1 to C10 alkyl group, a substituted or unsubstituted C1 to C10 alkoxy group, or a substituted or unsubstituted C1 to C10 alkylamine group,
X¹ to X³ are each independently a halogen group or —O—L^{a}—R^{a},
at least one of X¹ to X³ is —O—L^{a}—R^{a},
wherein L^{a}s are each independently a single bond or a substituted or unsubstituted C1 to C10 alkylene group, and
R^{a}s are each independently a cyano group (—CN), a difluorophosphite group (-OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
R^{a}s are each independently present, or
at least two R^{a}s are linked to form a substituted or unsubstituted monocyclic or polycyclic aliphatic heterocycle or a substituted or unsubstituted monocyclic or polycyclic aromatic heterocycle.

The composition may include the first compound and the second compound in a weight ratio of 0.5:1 to 10:1.

The composition may include the first compound and the second compound in a weight ratio of 5:1 to 10:1.

At least one of R¹ to R⁶ in Chemical Formula 1 may be a fluoro group (—F).

At least one of R¹ to R⁶ in Chemical Formula 1 may be a fluoro group (—F), and

at least one of the remaining R¹ to R⁶ may be a substituted or unsubstituted C1 to C10 alkoxy group or a substituted or unsubstituted C1 to C10 alkylamine group.

The first compound may be represented by Chemical Formula 1, and Chemical Formula 1 may be represented by Chemical Formula 1A or Chemical Formula 1B.

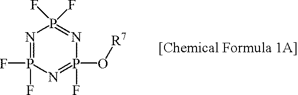

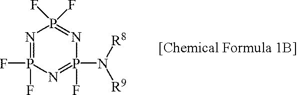

In Chemical Formula 1A and Chemical Formula 1B,

R⁷ to R⁹ are each independently a substituted or unsubstituted C1 to C10 alkyl group.

The first compound may be selected from compounds listed in Group 1.

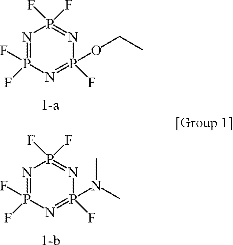

The second compound is represented by Chemical Formula 2, and

Chemical Formula 2 may be represented by any one of Chemical Formulas 2-1 to 2-3.

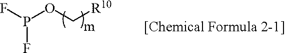

In Chemical Formula 2-1,
m is one of integers from 1 to 5, and
R¹⁰ is a cyano group (—CN) or a difluorophosphite group (—OPF₂);

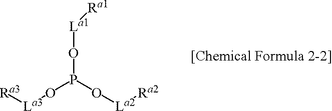

wherein, in Chemical Formula 2-2,
L^{a1} to L^{a3} are each independently a single bond or a substituted or unsubstituted C1 to C5 alkylene group, and
R^{a1} to R^{a3} are each independently a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group;

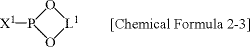

wherein, in Chemical Formula 2-3,
X¹ is a halogen group or —O—L^{a4}—R^{a4},
wherein L^{a4} is a single bond or a substituted or unsubstituted C1 to C5 alkylene group, and
R^{a4} is a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
L¹ is a substituted or unsubstituted C2 to C5 alkylene group.

The second compound may be any one selected from compounds listed in Group 2.

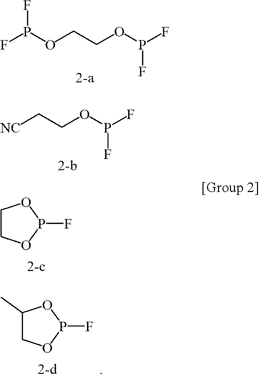

The first compound may be included in an amount of 0.1 to 5.0 wt% based on the total weight of the electrolyte for the rechargeable lithium battery.

The second compound may be included in an amount of 0.1 to 5.0 wt% based on the total weight of the electrolyte for the rechargeable lithium battery.

The composition may be included in an amount of 1.0 to 10 wt% based on the total weight of the electrolyte for the rechargeable lithium battery.

Another embodiment of the present invention provides a rechargeable lithium battery including a positive electrode including a positive electrode active material, a negative electrode including a negative electrode active material, and the aforementioned electrolyte for the rechargeable lithium battery.

### Advantageous Effects

Due to the additive with improved thermal safety, it is possible to implement a rechargeable lithium battery having improved high-temperature leaving characteristics by suppressing an increase in internal resistance and generation of gas after being left at a high temperature, and by suppressing a voltage drop.

### DESCRIPTION OF THE DRAWINGS

FIG. 1 is a schematic view showing a rechargeable lithium battery according to an embodiment of the present invention.

FIG. 2 is a graph showing operation times of current interrupt devices (CID) of the rechargeable lithium battery cells according to Examples 1 to 11 and Comparative Examples 1 to 7.

### DESCRIPTION OF SYMBOLS

100: rechargeable lithium battery
112: negative electrode
113: separator
114: positive electrode
120: battery case
140: sealing member

### MODE FOR INVENTION

Hereinafter, a rechargeable lithium battery according to an embodiment of the present invention will be described in detail with reference to the accompanying drawings. However, these embodiments are exemplary, the present invention is not limited thereto and the present invention is defined by the scope of claims.

In the present specification, unless otherwise defined, “substituted” means that at least one hydrogen in a substituent or compound is deuterium, a halogen group, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one example of the present invention, “substituted” refers to replacement of at least one hydrogen in a substituent or compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In one example of the present invention, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In addition, in specific examples of the present invention, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In addition, in specific examples of the present invention, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

A rechargeable lithium battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it may be bulk type and thin film type depending on sizes. Structures and manufacturing methods for lithium ion batteries pertaining to this disclosure are well known in the art.

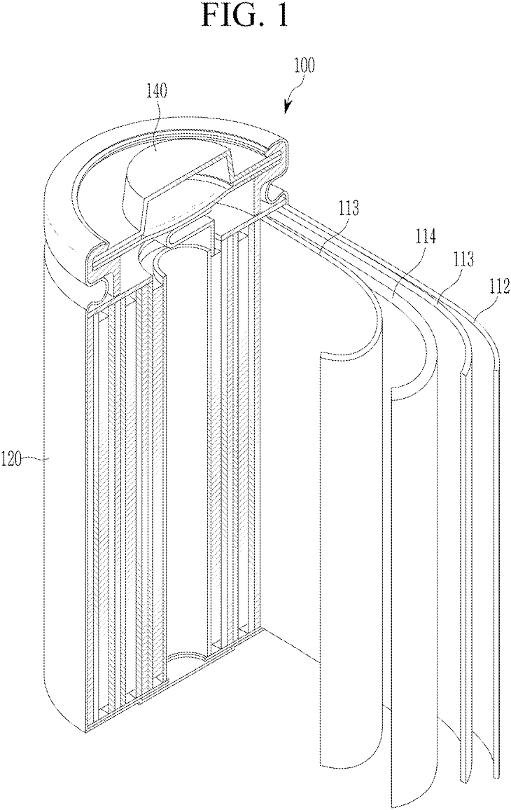

Herein, as an example of a rechargeable lithium battery, a cylindrical rechargeable lithium battery is for example described. FIG. 1 schematically illustrates the structure of a rechargeable lithium battery according to an embodiment. Referring to FIG. 1, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte (not shown) impregnating the positive electrode 114, negative electrode 112, and separator 113, a battery case 120 housing the battery cell, and a sealing member 140 sealing the battery case 120.

Hereinafter, a more detailed configuration of the rechargeable lithium battery 100 according to an embodiment of the present invention will be described.

A rechargeable lithium battery according to an embodiment of the present invention includes an electrolyte, a positive electrode, and a negative electrode.

The electrolyte includes a non-aqueous organic solvent, a lithium salt, and an additive, wherein the additive includes a composition including a first compound represented by Chemical Formula 1 and a second compound represented by Chemical Formula 2.

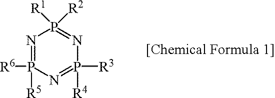

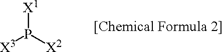

In Chemical Formula 1 and Chemical Formula 2,
R¹ to R⁶ are each independently hydrogen, a halogen, a substituted or unsubstituted C1 to C10 alkyl group, a substituted or unsubstituted C1 to C10 alkoxy group, or a substituted or unsubstituted C1 to C10 alkylamine group,
X¹ to X³ are each independently a halogen or —O—L^{a}—R^{a},
at least one of X¹ to X³ is —O—L^{a}—R^{a},
wherein L^{a}s are each independently a single bond or a substituted or unsubstituted C1 to C10 alkylene group, and
R^{a}s are each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
R^{a}s are each independently present, or
at least two R^{a}s are connected to form a substituted or unsubstituted monocyclic or polycyclic aliphatic heterocycle or a substituted or unsubstituted monocyclic or polycyclic aromatic heterocycle.

The first compound is a phosphazene-based compound. On ignition, when oxygen is generated due to decomposition of the electrolyte or the positive electrode active material, the first compound may trap this oxygen to prevent combustion. In addition, the first compound may trap a radical product and thus terminate a radical chain reaction, suppressing a side reaction in the battery. Furthermore, the first compound acts as a film decomposition additive and may from a film with low resistance.

That is, the composition may improve the high-temperature safety of the battery by including the first compound represented by Chemical Formula 1.

The second compound may be reduced and decomposed to form an SEI (solid electrolyte interface) film on the negative electrode and prevents the decomposition of the electrolyte and the resulting decomposition reaction of the electrodes, thereby suppressing an increase in internal resistance due to the gas generation.

In addition, when the second compound is included with the first compound together, the electrolyte may be suppressed from the high temperature decomposition effect through stabilization of a lithium salt in the electrolyte as well as from flame retardancy, improving the effect of improving gas generation inside the battery at a high temperature and simultaneously, improving battery safety and cycle-life characteristics.

When the first compound and the second compound are used in combination, the electrolyte may be suppressed from a side reaction through stabilization of a lithium salt in addition to flame retardancy, improving battery high temperature stability characteristics.

For example, the composition may include the first compound and the second compound in a weight ratio of 0.5:1 to 10:1.

As a specific example, the composition may include the first compound and the second compound in a weight ratio of 1 : 1 to 10 : 1, 2 : 1 to 10 : 1, or 3 : 1 to 10 : 1.

As a most specific example, the composition may include the first compound and the second compound in a weight ratio of 5:1 to 10:1.

For example, at least one of R¹ to R⁶ in Chemical Formula 1 may be a fluoro group (—F).

As a specific example, at least one of R¹ to R⁶ in Chemical Formula 1 is a fluoro group (—F)

at least one of the remaining R¹ to R⁶ may be a substituted or unsubstituted C1 to C10 alkoxy group or a substituted or unsubstituted C1 to C10 alkylamine group.

As a more specific example, the first compound is represented by Chemical Formula 1, and Chemical Formula 1 may be represented by Chemical Formula 1A or Chemical Formula 1B.

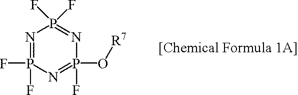

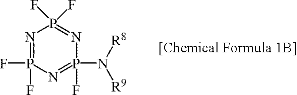

In Chemical Formula 1A and Chemical Formula 1B,

R⁷ to R⁹ are each independently a substituted or unsubstituted C1 to C10 alkyl group.

For example, the first compound may be selected from compounds listed in Group 1.

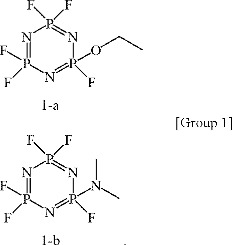

For example, the second compound is represented by Chemical Formula 2,

Chemical Formula 2 may be represented by any one of Chemical Formulas 2-1 to 2-3.

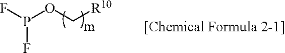

In Chemical Formula 2-1,
m is one of integers from 1 to 5, and
R¹⁰ is a cyano group (—CN) or a difluorophosphite group (-OPF₂);

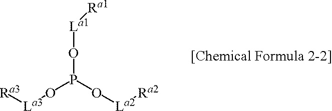

wherein, in Chemical Formula 2-2,
L^{a1} to L^{a3} are each independently a single bond or a substituted or unsubstituted C1 to C5 alkylene group, and
R^{a1} to R^{a3} are each independently a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group;

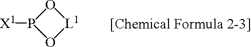

wherein, in Chemical Formula 2-3,
X¹ is a halogen group or —O—L^{a4}—R^{a4},
L^{a4} is a single bond or a substituted or unsubstituted C1 to C5 alkylene group,
R^{a4} is a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
L¹ is a substituted or unsubstituted C2 to C5 alkylene group.

As a specific example, the second compound may be represented by Chemical Formula 2-1 or Chemical Formula 2-3.

For example, the second compound may be any one selected from compounds listed in Group 2.

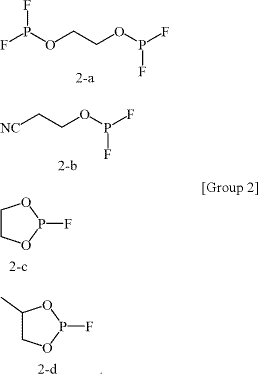

According to the most specific embodiment, the additive included in the electrolyte for the rechargeable lithium battery according to the present invention may be a composition including at least one of the compounds listed in Group 1 as the first compound and at least one of the compounds listed in Group 2 as the second compound.

For example, the additive included in the electrolyte for the rechargeable lithium battery according to the present invention may be a composition including any one of Compound 1-a or Compound 1-b of Group 1 as a first compound and Compound 2-a or Compound 2-d of Group 2 as a second compound.

In an embodiment, the first compound and the second compound may be included in a weight ratio of about 0.5: 1, about 1: 1, about 2: 1, about 3: 1, about 5: 1, or about 10: 1.

Meanwhile, the first compound may be included in an amount of about 0.1 wt% to about 5.0 wt% based on the total weight of the electrolyte for the rechargeable lithium battery.

For example, it may be included in 0.2 wt% to about 5.0 wt%, for example, about 0.25 wt%, about 0.5 wt%, about 1.0 wt%, about 1.5 wt%, about 2.5 wt% or about 5.0 wt%.

In addition, the second compound may be included in an amount of 0.1 to 5.0 wt% based on the total weight of the electrolyte for the rechargeable lithium battery.

For example, it may be included in about 0.2 wt% to about 5.0 wt%, about 0.3 wt% to about 5.0 wt%, about 0.4 wt% to about 5.0 wt%, or about 0.5 wt% to about 5.0 wt%, for example about 0.5 wt%, about 1.0 wt%, about 2.5 wt% wt% or about 5.0 wt%.

The composition including the first compound and the second compound may be included in an amount of about 1.0 wt% to about 10 wt% based on the total weight of the electrolyte for the rechargeable lithium battery.

For example, the composition including the first compound and the second compound may be included in an amount of about 0.75 wt%, about 1.0 wt%, about 1.5 wt%, about 2.0 wt%, about 3.0 wt%, about 5.5 wt%, about 6.0 wt%, about 7.5 wt% or about 10 wt% based on the total weight of the electrolyte for the rechargeable lithium battery.

When the contents of the composition and each component, that is, the first compound and the second compound in the composition, are within the above ranges, it is possible to realize a rechargeable lithium battery with improved thermal stability and suppressed generation of gas inside the battery, thereby improving battery characteristics at room temperature and high temperature.

The non-aqueous organic solvent serves as a medium for transmitting ions taking part in the electrochemical reaction of a battery.

The non-aqueous organic solvent serves as a medium for transmitting ions taking part in the electrochemical reaction of a battery.

The carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. The ester-based solvent may be methyl acetate, ethyl acetate, n-propyl acetate, t-butyl acetate, methyl propionate, ethyl propionate, propyl propionate, decanolide, mevalonolactone, caprolactone, and the like. The ether-based solvent may be dibutyl ether, tetraglyme, diglyme, dimethoxyethane, 2-methyltetrahydrofuran, tetrahydrofuran, and the like. In addition, the ketone-based solvent may be cyclohexanone, and the like. The alcohol-based solvent may include ethanol, isopropyl alcohol, and the like, and the aprotic solvent may include nitriles such as R¹—CN (wherein R¹ is a hydrocarbon group having a C2 to C20 linear, branched, or cyclic structure and may include a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used alone or in a mixture, and when used in a mixture, the mixing ratio may be appropriately adjusted in accordance with a desired battery performance, which is widely understood by those skilled in the art.

The carbonate-based solvent is prepared by mixing a cyclic carbonate and a chain carbonate. When the cyclic carbonate and chain carbonate are mixed together in a volume ratio of 1:9 to 9:1, a performance of the electrolyte may be improved.

In particular, in an embodiment, the non-aqueous organic solvent may include the cyclic carbonate and the chain carbonate in a volume ratio of 2:8 to 5:5, and as a specific example, the cyclic carbonate and the chain carbonate may be included in a volume ratio of 2:8 to 4:6.

More specifically, the cyclic carbonate and the chain carbonate may be included in a volume ratio of 2:8 to 3:7.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 3.

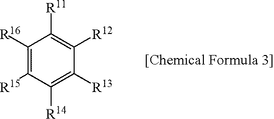

In Chemical Formula 3, R¹¹ to R¹⁶ are the same or different and are hydrogen, a halogen, a C1 to C10 alkyl group, a haloalkyl group, or a combination thereof.

Specific examples of the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate, vinyl ethylene carbonate, or an ethylene carbonate-based compound represented by Chemical Formula 4 as an additive to improve cycle-life of a battery.

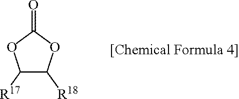

In Chemical Formula 4, R¹⁷ and R¹⁸ are the same or different, and are selected from hydrogen, a halogen, a cyano group (CN), a nitro group (NO₂), and a fluorinated C1 to C5 alkyl group, provided that at least one of R¹⁷ and R¹⁸ is selected from a halogen, a cyano group (CN), a nitro group (NO₂), and a fluorinated C1 to C5 alkyl group, and both R¹⁷ and R¹⁸ are not hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. When such an additive for improving cycle-life is further used, its amount may be appropriately adjusted.

The lithium salt dissolved in the non-organic solvent supplies lithium ions in a battery, enables a basic operation of a rechargeable lithium battery, and improves transportation of the lithium ions between positive and negative electrodes. Examples of the lithium salt may include one or more selected from LiPF₆, LiBF₄, LiSbF₆, LiAsFₛ, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, for example an integer of 1 to 20), LiCl, Lil, LiB(C₂O₄)₂ (lithium bis(oxalato) borate: LiBOB), LiDFOB (lithium difluoro(oxalato)borate), and Li[PF₂(C₂O₄)_{2]} (lithium difluoro (bis oxalato) phosphate). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

The positive electrode includes a positive electrode current collector and a positive electrode active material layer on the positive electrode current collector, and the positive electrode active material layer includes a positive electrode active material.

The positive electrode active material may include lithiated intercalation compounds that reversibly intercalate and deintercalate lithium ions.

Specifically, one or more of a composite oxide of a metal selected from cobalt, manganese, nickel, and a combination thereof and lithium may be used.

Of course, one having a coating layer on the surface of the lithium composite oxide may be used, or a mixture of the composite oxide and a compound having a coating layer may be used. The coating layer may include one or more coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any conventional processes as long as it does not cause any side effects on the properties of the positive electrode active material (e.g., inkjet coating, dipping), which is well known to persons having ordinary skill in this art, so a detailed description thereof is omitted.

The positive electrode active material may be, for example, one or more of lithium composite oxides represented by Chemical Formula 5.

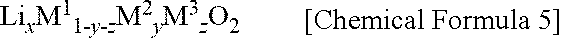

In Chemical Formula 5,

0.5≤x≤1.8, 0≤y<1, 0≤z<1, 0≤y+z<1, and M¹, M², and M³ are each independently any one selected from a metal such as Ni, Co, Mn, Al, Sr, Mg, or La, and a combination thereof.

In an embodiment, M¹ may be a metal such as Co, Mn, Al, Sr, Mg, or La, and M² and M³ may each independently be Ni or Co.

In a specific embodiment, M¹ may be Mn or Al, and M² and M³ may each independently be Ni or Co, but they are not limited thereto.

In a more specific embodiment, the positive electrode active material may be a lithium composite oxide represented by any one of Chemical Formulas 5-1 to 5-3.

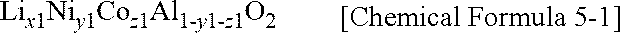

In Chemical Formula 5-1, 1≤x1≤1.2, 0<y1<1, and 0<z1<1.

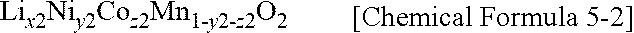

In Chemical Formula 5-2,

1≤x2≤1.2, 0<y2<1, and 0<z2<1.

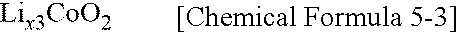

In Chemical Formula 5-3,

0.5<x3 ≤1.

For example, in Chemical Formula 5-1, 1≤x1≤1.2, 0.5≤y1<1, and 0<z1≤0.5.

As a specific example, in Chemical Formula 5-1, 1 ≤x1≤1.2, 0.6≤y1<1, and 0<z1 ≤ 0.5.

As a more specific example, in Chemical Formula 5-1, 1≤x1≤1.2, 0.7≤y1<1, and 0<z1≤0.5.

For example, in Chemical Formula 5-1, 1≤x1≤1.2, 0.8≤y1<1, and 0<z1 ≤ 0.5.

For example, in Chemical Formula 5-2, 1≤x2≤1.2, 0.3≤y2<1, and 0.3≤z2<1.

As a specific example, in Chemical Formula 5-2, 1 ≤x2≤ 1.2, 0.6≤y2<1, and 0.3≤z2<1.

As a more specific example, in Chemical Formula 5-2, 1≤x2≤1.2, 0.7≤y2<1, and 0.3≤z2<1.

For example, in Chemical Formula 5-2, 1≤x2≤1.2, 0.8≤y2<1, and 0.3≤z2<1.

A content of the positive electrode active material may be 90 wt% to 98 wt% based on the total weight of the positive electrode active material layer.

In an embodiment of the present invention, the positive electrode active material layer may optionally include a conductive material and a binder. In this case, a content of the conductive material and the binder may be 1 wt% to 5 wt%, respectively, based on the total weight of the positive electrode active material layer.

The conductive material is included to impart conductivity to the positive electrode and any electrically conductive material may be used as a conductive material unless it causes a chemical change in the configured battery. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The positive electrode current collector may include Al, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions includes carbon materials. The carbon material may be any generally-used carbon-based negative electrode active material in a rechargeable lithium battery and examples of the carbon material include crystalline carbon, amorphous carbon, and a combination thereof. The crystalline carbon may be non-shaped, or sheet, flake, spherical, or fiber shaped natural graphite or artificial graphite and the amorphous carbon may be a soft carbon, a hard carbon, a mesophase pitch carbonization product, calcined coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si-C composite, SiOₓ (0 < x < 2), a Si-Q alloy wherein Q is an element selected from an alkali metal, an alkaline-earth metal, a Group 13 element, a Group 14 element, a Group 15 element, a Group 16 element, a transition metal, a rare earth element, and a combination thereof, but not Si), Sn, SnO₂, a Sn—R²² alloy (wherein R²² is an element selected from an alkali metal, an alkaline-earth metal, a Group 13 element, a Group 14 element, a Group 15 element, a Group 16 element, a transition metal, a rare earth element, and a combination thereof, but not Sn), and the like. One or more of these materials may be mixed with SiO₂.

The elements Q and R²² may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The transition metal oxide may be a vanadium oxide, a lithium vanadium oxide, and the like.

In a specific embodiment, the negative electrode active material may be a Si—C composite including a Si-based active material and a carbon-based active material.

An average particle diameter of the Si-based active material in the Si-C composite may be 50 nm to 200 nm.

When the average particle diameter of the Si-based active material is within the above range, volume expansion occurring during charging and discharging may be suppressed, and a break in a conductive path due to particle crushing during charging and discharging may be prevented.

The Si-based active material may be included in an amount of 1 wt% to 60 wt%, for example, 3 wt% to 60 wt% based on the total weight of the Si-C composite.

In another specific embodiment, the negative electrode active material may further include crystalline carbon together with the aforementioned Si-C composite.

When the negative electrode active material includes a Si—C composite and crystalline carbon together, the Si—C composite and crystalline carbon may be included in the form of a mixture, and in this case, the Si—C composite and crystalline carbon may be included in a weight ratio of 1:99 to 50:50. More specifically, the Si—C composite and crystalline carbon may be included in a weight ratio of 5 : 95 to 20 : 80.

The crystalline carbon may include, for example, graphite, and more specifically, natural graphite, artificial graphite, or a mixture thereof.

An average particle diameter of the crystalline carbon may be 5 µm to 30 µm.

In the present specification, an average particle diameter may be a particle size (D50) at a volume ratio of 50% in a cumulative size-distribution curve.

The Si—C composite may further include a shell surrounding a surface of the Si—C composite, and the shell may include amorphous carbon.

The amorphous carbon may include soft carbon, hard carbon, a mesophase pitch carbonized product, calcined coke, or a mixture thereof.

The amorphous carbon may be included in an amount of 1 to 50 parts by weight, for example, 5 to 50 parts by weight, or 10 to 50 parts by weight based on 100 parts by weight of the carbon-based active material.

In the negative electrode active material layer, the negative electrode active material may be included in an amount of 95 wt% to 99 wt% based on the total weight of the negative electrode active material layer.

In an embodiment, the negative electrode active material layer may include a binder, and optionally a conductive material. The content of the binder in the negative electrode active material layer may be 1 wt% to 5 wt% based on the total weight of the negative electrode active material layer. In addition, when the conductive material is further included, 90 wt% to 98 wt% of the negative electrode active material, 1 wt% to 5 wt% of the binder, and 1 wt% to 5 wt% of the conductive material may be used.

The binder improves binding properties of negative electrode active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropyleneco polymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the water-soluble binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 parts by weight to 3 parts by weight based on 100 parts by weight of the negative electrode active material.

The conductive material is included to improve electrode conductivity and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The negative electrode current collector may be selected from a copper foil, a nickel foil, a stainless-steel foil, a titanium foil, a nickel foam, a copper foam, a polymer substrate coated with a conductive metal, and a combination thereof.

The rechargeable lithium battery may further include a separator between the negative electrode and the positive electrode, depending on a type of the battery. Such a separator may be a porous substrate or a composite porous substrate.

The porous substrate may be a substrate including pores, and lithium ions may move through the pores. The porous substrate may for example include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The composite porous substrate may have a form including a porous substrate and a functional layer on the porous substrate. The functional layer may be, for example, one or more of a heat-resistant layer and an adhesive layer from the viewpoint of enabling additional function. For example, the heat-resistant layer may include a heat-resistant resin and optionally a filler.

In addition, the adhesive layer may include an adhesive resin and optionally a filler.

The filler may be an organic filler or an inorganic filler.

### DETAILED DESCRIPTION OF THE EMBODIMENTS

Hereinafter, examples of the present invention and comparative examples are described. These examples, however, are not in any sense to be interpreted as limiting the scope of the invention.

### Synthesis Example: Synthesis of Compound 1-b

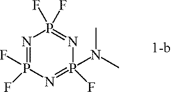

Compound 1-b was synthesized with reference to published patent KR2013-0124180.

### Manufacture of Rechargeable Lithium Battery Cells

### Example 1

LiNi_{0.91}Co_{0.07}AI_{0.02}O2 as a positive electrode active material, polyvinylidene fluoride as a binder, and ketjen black as a conductive material were mixed in a weight ratio of 97:2:1 and then, dispersed in N-methyl pyrrolidone, preparing positive electrode active material slurry.

The positive electrode active material slurry was coated on a 14 µm-thick Al foil, dried at 110° C., and pressed, manufacturing a positive electrode.

A negative electrode active material prepared by mixing artificial graphite and an Si—C composite in a weight ratio of 93:7, a styrene-butadiene rubber binder as a binder, and carboxylmethyl cellulose as a thickener were mixed in a weight ratio of 97:1:2 and then, dispersed in distilled water, preparing negative electrode active material slurry.

The Si—C composite included a core including artificial graphite and silicon particles and coal-based pitch coated on the surface of the core.

The negative electrode active material slurry was coated on a 10 µm-thick Cu and then, dried at 100° C. and pressed, manufacturing a negative electrode.

The positive electrode and the negative electrode were assembled with a 25 µm-thick polyethylene separator to manufacture an electrode assembly, and an electrolyte was injected thereinto, manufacturing a rechargeable lithium battery cell.

The electrolyte has a composition as follows.
(Composition of electrolyte)
Salt: 1.5 M LiPF₆
Solvent: ethylene carbonate: ethylmethyl carbonate: dimethyl carbonate (EC: EMC:DMC = a volume ratio of 20:10:70)
Additive: Composition including 5.0 wt% of Compound 1-a and 0.5 wt% of Compound 2-a
(In the composition of the electrolyte, “wt%” is based on the total content (lithium salt + non-aqueous organic solvent))

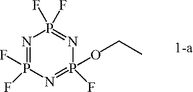

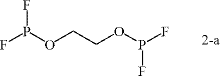

### Example 2

A rechargeable lithium battery cell was manufactured in the same manner as in Example 1, except that the additive composition was prepared by changing Compound 1-a to 2.5 wt%.

### Example 3

A rechargeable lithium battery cell was manufactured in the same manner as in Example 1, except that the additive composition was prepared by changing Compound 1-a to 1.5 wt%.

### Example 4

A rechargeable lithium battery cell was manufactured in the same manner as in Example 1, except that the additive composition was prepared by changing Compound 1-a to 1.0 wt%.

### Example 5

A rechargeable lithium battery cell was manufactured in the same manner as in Example 1, except that the additive composition was prepared by changing Compound 1-a to 0.5 wt%.

### Example 6

A rechargeable lithium battery cell was manufactured in the same manner as in Example 1, except that the additive composition was prepared by changing Compound 1-a to 0.25 wt%.

### Example 7

A rechargeable lithium battery cell was manufactured in the same manner as in Example 1, except that the additive composition was prepared by changing Compound 2-a to 1.0 wt%.

### Example 8

A rechargeable lithium battery cell was manufactured in the same manner as in Example 1, except that the additive composition was prepared by changing Compound 2-a to 2.5 wt%.

### Example 9

A rechargeable lithium battery cell was manufactured in the same manner as in Example 1, except that the additive composition was prepared by changing Compound 2-a to 5.0 wt%.

### Example 10

A rechargeable lithium battery cell was manufactured in the same manner as in Example 1, except for preparing the additive composition by changing Compounds 1-a to 1-b.

### Example 11

A rechargeable lithium battery cell was manufactured in the same manner as in Example 1, except for preparing the additive composition by changing Compound 2-a to Compound 2-d.

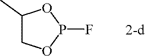

### Comparative Example 1

A rechargeable lithium battery cell was manufactured in the same manner as in Example 1, except for using an electrolyte without additives.

### Comparative Example 2

A rechargeable lithium battery cell was manufactured in the same manner as in Example 1, except that the electrolyte was prepared with an additive not using Compound 2-a in the composition.

### Comparative Example 3

A rechargeable lithium battery cell was manufactured in the same manner as in Example 1, except that the electrolyte was prepared with an additive not using Compound 1-a in the composition.

### Comparative Example 4

A rechargeable lithium battery cell was manufactured in the same manner as in Example 1, except that the additive composition was prepared by changing Compound 2-a in the composition to Compound i (tris(1,1,1,3,3,3-hexafluoroisopropyl) phosphate).

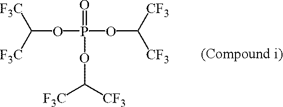 [SMILES: O=P(OC(C(F)(F)F)C(F)(F)F)(OC(C(F)(F)F)C(F)(F)F)OC(C(F)(F)F)C(F)(F)F]

### Comparative Example 5

A rechargeable lithium battery cell was manufactured in the same manner as in Example 1, except that the additive composition was prepared by changing Compound 2-a in the composition to Compound ii (tris(trimethylsilyl) phosphite).

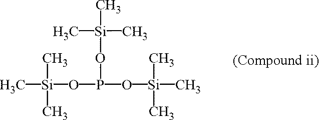

### Comparative Example 6

A rechargeable lithium battery cell was manufactured in the same manner as in Example 1, except that the additive composition was prepared by changing Compound 1-a to 0.05 wt%.

### Comparative Example 7

A rechargeable lithium battery cell was manufactured in the same manner as in Example 1, except that the additive composition was prepared by changing Compound 1-a to 10 wt%.

The additive compositions of the rechargeable lithium battery according to Examples 1 to 11 and Comparative Examples 1 to 7 are as shown in Table 1.

TABLE 1

Additive composition

| | First compound (wt%) | Second compound (wt%) | Mixing ratio |
|---|---|---|---|
| Example 1 | Compound 1-a (5.0) | Compound 2-a (0.5) | 10:1 |
| Example 2 | Compound 1-a 2.5 | Compound 2-a (0.5) | 5:1 |
| Example 3 | Compound 1-a 1.5 | Compound 2-a (0.5) | 3:1 |
| Example 4 | Compound 1-a 1.0 | Compound 2-a (0.5) | 2:1 |
| Example 5 | Compound 1-a 0.5 | Compound 2-a (0.5) | 1:1 |
| Example 6 | Compound 1-a 0.25 | Compound 2-a (0.5) | 0.5:1 |
| Example 7 | Compound 1-a (5.0) | Compound 2-a (1.0) | 5:1 |
| Example 8 | Compound 1-a (5.0) | Compound 2-a (2.5) | 2:1 |
| Example 9 | Compound 1-a (5.0) | Compound 2-a (5.0) | 1:1 |
| Example 10 | Compound 1-b 5.0 | Compound 2-a (0.5) | 10:1 |
| Example 11 | Compound 1-a (5.0) | compound 2-d (0.5) | 10:1 |
| Comparative Example 1 | - | - | - |
| Comparative Example 2 | Compound 1-a (5.0) | - | - |
| Comparative Example 3 | - | Compound 2-a (0.5) | - |
| Comparative Example 4 | Compound 1-a (5.0) | Compound i (0.5) | 10:1 |
| Comparative Example 5 | Compound 1-a (5.0) | Compound ii (0.5) | 10:1 |
| Comparative Example 6 | Compound 1-a (0.05) | Compound 2-a (0.5) | 0.1:1 |
| Comparative Example 7 | Compound 1-a (10) | Compound 2-a (0.5) | 20:1 |

### Evaluation 1: Penetration Safety Evaluation

The rechargeable lithium battery cells according to Examples 1 to 11 and Comparative Examples 1 to 7 were evaluated with respect to penetration characteristics in the following method, and the results are shown in Table 2.

A penetration limit test was performed to evaluate battery safety by charging each cell to SOC (state of charge) 50 (capacity corresponding to a half of a total capacity of 100) and SOC (state of charge) 70 (capacity corresponding to 70% of a total capacity of 100) and then, penetrating the cells with a 3.0 pi nail at 150 mm/s. The criteria is as follows;
(Evaluation Criteria)
L0: no reaction
L1: leakage
L2: exothermic at less than 200° C.
L3: fumes, exothermic at greater than or equal to 200° C.
L4: ignition
L5: explosion

TABLE 2

| | | |
|---|---|---|
| | SOC 50 | SOC 70 |
| Example 1 | L0 | L0 |
| Example 2 | L0 | L0 |
| Example 3 | L1 | L1 |
| Example 4 | L1 | L1 |
| Example 5 | L1 | L1 |
| Example 6 | L1 | L1 |
| Example 7 | L1 | L0 |
| Example 8 | L1 | L1 |
| Example 9 | L1 | L1 |
| Example 10 | L0 | L0 |
| Example 11 | L0 | L0 |
| Comparative Example 1 | L5 | L5 |
| Comparative Example 2 | L1 | L5 |
| Comparative Example 3 | L5 | L5 |
| Comparative Example 4 | L5 | L5 |
| Comparative Example 5 | L5 | L5 |
| Comparative Example 6 | L4 | L4 |
| Comparative Example 7 | L4 | L4 |

Referring to Table 2, the rechargeable lithium battery cells according to Examples 1 to 11 turned out to have excellent penetration safety, compared with the rechargeable lithium battery cells according to Comparative Examples 1 to 7.

In other words, this excellent effect was not realized, when in the composition of the additive according to the present invention, any component was missing, some compounds were changed into other types of compounds, or the composition of the additive was out of the specific ranges.

### Evaluation 2: Evaluation of High-Temperature Leaving Characteristics

The rechargeable lithium battery cells of Examples 1 to 11 and Comparative Examples 1 to 7 were charged at a charge and discharge rate of 0.5 C in a mode of 4.35 V CC/CV for 3 hours and then, left in a 90° C. chamber for 110 hours to measure an operation time of CID (Current Interrupt Device).

The CID (Current Interrupt Device) is a device detecting a pressure change, that is, a pressure increase in the closed and sealed device and cutting off a current by itself, when the pressure exceeds a certain pressure, which is obvious in the art and thus will not be illustrated in detail.

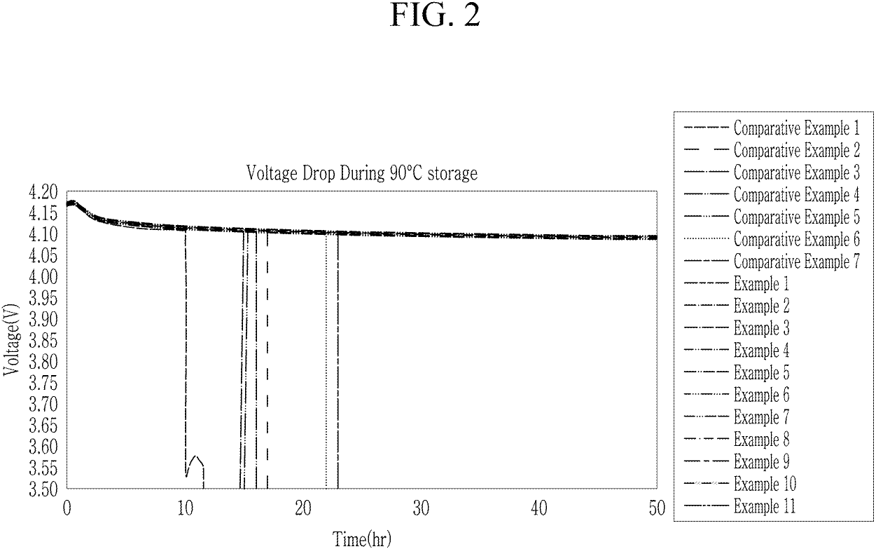

CID operation times of the rechargeable lithium battery cells were measured to evaluate high-temperature leaving characteristics, and the results are shown in FIG. 2.

FIG. 2 is a graph showing operation times of current interrupt devices (CID) of the rechargeable lithium battery cells according to Examples 1 to 11 and Comparative Examples 1 to 7.

In addition, the CID operation times were measured to evaluate high-temperature storage characteristics of the rechargeable lithium battery cells.

Referring to FIG. 2, Comparative Examples 1 to 5, when at least one compound was omitted in the composition of the present invention, a sharp voltage drop appeared before about 30 hours at a high-temperature storage of 90° C., but the examples including the additive according to an example embodiment of the present invention exhibited no voltage drop to at least 50 hours, which confirmed that the additive brought about an effect of delaying the OCV drop by delaying the electrolyte decomposition and thus reducing the resistance increase.

In addition, Comparative Examples 6 and 7, in which the mixing ratio of the additive was out of the specific range, exhibited a sharp voltage drop before about 30 hours, but the examples including the additive according to an example embodiment of the present invention exhibited no voltage drop to at least 50 hours and thus a gas-reducing effect. Accordingly, the examples turned out to exhibit an effect of delaying the OCV drop by delaying the electrolyte decomposition and thus reducing the resistance increase.

In other words, the rechargeable lithium battery cells according to the present invention exhibited an excellent effect of suppressing the gas generation during the high-temperature storage.

Therefore, in the case of a rechargeable lithium battery using the specific combination of the composition according to the present embodiment as an additive, improved penetration safety and high-temperature leaving characteristics may be implemented.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An electrolyte for a rechargeable lithium battery, comprising
a non-aqueous organic solvent,
a lithium salt, and
an additive,
wherein the additive is a composition including a first compound represented by Chemical Formula 1 and a second compound represented by Chemical Formula 2: 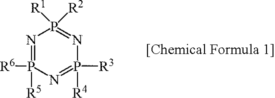 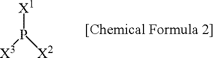
wherein, in Chemical Formula 1 and Chemical Formula 2,
R¹ to R⁶ are each independently hydrogen, a halogen, a substituted or unsubstituted C1 to C10 alkyl group, a substituted or unsubstituted C1 to C10 alkoxy group, or a substituted or unsubstituted C1 to C10 alkylamine group,
X¹ to X³ are each independently a halogen or —O—L^{a}—R^{a},
at least one of X¹ to X³ is —O—L^{a}—R^{a},
wherein L^{a}s are each independently a single bond or a substituted or unsubstituted C1 to C10 alkylene group, and
R^{a}s are each independently a cyano group (—CN), a difluorophosphite group (-OPF₂), a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
R^{a}s are each independently present, or
at least two R^{a}s are connected to form a substituted or unsubstituted monocyclic or polycyclic aliphatic heterocycle or a substituted or unsubstituted monocyclic or polycyclic aromatic heterocycle.

2. The electrolyte for the rechargeable lithium battery of claim 1, wherein
the composition includes the first compound and the second compound in a weight ratio of 0.5:1 to 10:1.

3. The electrolyte for the rechargeable lithium battery of claim 1, wherein
the composition includes the first compound and the second compound in a weight ratio of 5:1 to 10:1.

4. The electrolyte for the rechargeable lithium battery of claim 1, wherein
at least one of R¹ to R⁶ in Chemical Formula 1 is a fluoro group (—F),.

5. The electrolyte for the rechargeable lithium battery of claim 1, wherein
at least one of R¹ to R⁶ in Chemical Formula 1 is a fluoro group (—F), wherein at least one of the remaining R¹ to R⁶ is a substituted or unsubstituted C1 to C10 alkoxy group or a substituted or unsubstituted C1 to C10 alkylamine group.

6. The electrolyte for the rechargeable lithium battery of claim 1, wherein
the first compound is represented by Chemical Formula 1, and Chemical Formula 1 is represented by Chemical Formula 1A or Chemical Formula 1B: 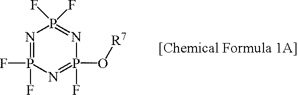 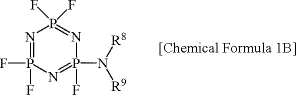
wherein, in Chemical Formula 1A and Chemical Formula 1B,
R⁷ to R⁹ are each independently a substituted or unsubstituted C1 to C10 alkyl group.

7. The electrolyte for the rechargeable lithium battery of claim 1, wherein
the first compound is any one selected from the compounds listed in Group 1: 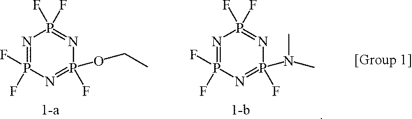
.

8. The electrolyte for the rechargeable lithium battery of claim 1, wherein
the second compound is represented by Chemical Formula 2, and
Chemical Formula 2 is represented by any one of Chemical Formula 2-1 to Chemical Formula 2-3: 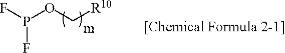
wherein, in Chemical Formula 2-1,
m is one of integers from 1 to 5, and
R¹⁰ is a cyano group (—CN) or a difluorophosphite group (—OPF₂); 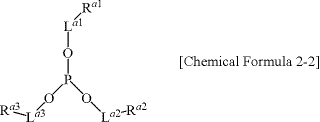
wherein, in Chemical Formula 2-2,
L^{a1} to L^{a3} are each independently a single bond or a substituted or unsubstituted C1 to C5 alkylene group, and
R^{a1} to R^{a3} are each independently a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group; 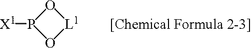
wherein, in Chemical Formula 2-3,
X¹ is a halogen group or —O—L^{a4}—R^{a4},
L^{a4} is a single bond or a substituted or unsubstituted C1 to C5 alkylene group,
R^{a4} is a substituted or unsubstituted C1 to C10 alkyl group, a substituted or unsubstituted C2 to C10 alkenyl group, a substituted or unsubstituted C2 to C10 alkynyl group, a substituted or unsubstituted C3 to C10 cycloalkyl group, a substituted or unsubstituted C3 to C10 cycloalkenyl group, a substituted or unsubstituted C3 to C10 cycloalkynyl group, or a substituted or unsubstituted C6 to C20 aryl group, and
L¹ is a substituted or unsubstituted C2 to C5 alkylene group.

9. The electrolyte for the rechargeable lithium battery of claim 1, wherein
the second compound is any one selected from compounds listed in Group 2: 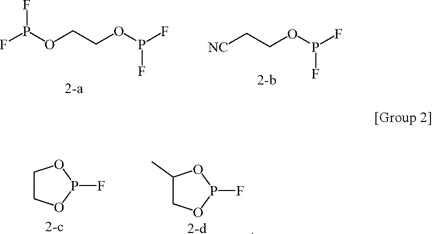
.

10. The electrolyte for the rechargeable lithium battery of claim 1, wherein
the first compound is included in an amount of 0.1 wt% to 5.0 wt% based on the total weight of the electrolyte for the rechargeable lithium battery.

11. The electrolyte for the rechargeable lithium battery of claim 1, wherein
the second compound is included in an amount of 0.1 wt% to 5.0 wt% based on the total weight of the electrolyte for the rechargeable lithium battery.

12. The electrolyte for the rechargeable lithium battery of claim 1, wherein
the composition is included in an amount of 1.0 wt% to 10 wt% based on the total weight of the electrolyte for the rechargeable lithium battery.

13. A rechargeable lithium battery comprising
a positive electrode including a positive electrode active material;
a negative electrode including a negative electrode active material; and
the electrolyte for the rechargeable lithium battery of claim 1.
